(19) United States
(12) Patent Application Publication
(10) Pub. No.: US 2020/0346578 A1
(43) Pub. Date: Nov. 5, 2020

(54) WORK VEHICLE HAVING A VISUAL INDICATOR ON A MOVING MEMBER

(71) Applicant: Deere & Company, Moline, IL (US)

(72) Inventors: Michael G. Kean, Maquoketa, IA (US); Zimin W. Vilar, Asbury, IA (US); Bret Teusink, Dubuque, IA (US)

(21) Appl. No.: 16/398,955

(22) Filed: Apr. 30, 2019

(51) Int. Cl. B60Q 1/26; B60Q 1/00; G01B 11/22

(52) U.S. Cl. CPC B60Q 1/2615; B60Q 1/2607; B60Y 2400/301; G01B 11/22; B60Y 2200/41; B60Q 1/0023

(57) ABSTRACT

A work vehicle includes a vehicle frame and an operator control station coupled to the vehicle frame. An implement arm assembly is affixed to the vehicle frame outside the operator control station. The implement arm assembly is movable relative to the vehicle frame and the operator control station. The implement arm assembly has an exterior surface. The work vehicle includes at least one sensor to detect positional information of the implement arm assembly. A visual indicator is positioned on the exterior surface. A power source of the work vehicle is in selective communication with the visual indicator to power the visual indicator. The work vehicle further includes a controller to receive a signal from the at least one sensor indicative of the positional information and electrically couple the power source to the visual indicator in response to a portion of the implement am assembly reaching a threshold position.

### FIELD OF THE DISCLOSURE

The present disclosure relates to work vehicles, and specifically to a work vehicle including a condition detection and indication system.

### BACKGROUND

Work vehicles are often used to manipulate a surface (e.g., the ground) or to move materials (e.g., dirt, crop). For example, work vehicles are used to contour and smooth out the surface of a construction site with a work implement. The work implement is used to manipulate the surface or to move surface or near-surface materials. The work implement is in some applications a blade capable of moving ground and dirt to create a desired surface contour. In other applications, however, the work implement may be a shovel or other tool capable of manipulating the ground or otherwise moving materials.

While a user is operating the work vehicle, the user sets a desired depth and slope he wishes to cut in the ground to create the desired surface contour. The work vehicle may include a grade monitoring and indication system. The work vehicle senses the cut made in the ground by the work implement and provides feedback to the user as to whether the work implement is on-grade, above grade, or below grade. This feedback is typically provided using an audible tone so the user can keep his eyes on the ground and/or the work implement while digging.

Providing additional or alternative feedback to the user while digging may improve or simplify the operation of the work vehicle. Accordingly, the disclosure provided herein describes a work vehicle and a method of operating a work vehicle including additional or alternative feedback.

### SUMMARY

In one embodiment, a work vehicle includes a vehicle frame. An operator control station is coupled to the vehicle frame. An implement arm assembly is affixed to the vehicle frame outside the operator control station. The implement arm assembly is movable relative to the vehicle frame and the operator control station. The implement arm assembly has an exterior surface. The work vehicle also includes at least one sensor able to detect positional information of the implement arm assembly. A visual indicator is positioned on the exterior surface of the implement arm assembly. A power source of the work vehicle is in selective communication with the visual indicator to power the visual indicator. The work vehicle further includes a controller. The controller is able to receive a signal from the at least one sensor indicative of the positional information and electrically couple the power source to the visual indicator in response to a portion of the implement am assembly reaching a threshold position.

In another embodiment, a work vehicle includes a vehicle frame. An operator control station is coupled to the vehicle frame. An implement arm assembly of the work vehicle is affixed to the vehicle frame outside the operator control station. The implement arm assembly is movable relative to the vehicle frame and the operator control station. The implement arm assembly has an exterior surface. The work vehicle also includes at least one sensor able to detect weight information of a load carried by the implement arm assembly. A visual indicator is positioned on the exterior surface of the implement arm assembly. A power source of the work vehicle is in selective communication with the visual indicator to power the visual indicator. The work vehicle further includes a controller. The controller is able to receive a signal from the at least one sensor indicative of the weight information and electrically couple the power source to the visual indicator once the weight of the load carried by the implement arm assembly exceeds a threshold weight.

In still another embodiment, a visual indication system includes at least one sensor, a visual indicator, and a controller. The at least one sensor is able to detect positional information of an implement arm assembly of a work vehicle. The visual indicator is able to be affixed to the implement arm assembly to illuminate an exterior surface of the implement arm assembly outside of an operator control station of the work vehicle. The controller is able to receive an input signal regarding a boundary of operational position of the portion of the implement arm assembly, receive a signal from the at least one sensor indicative of the positional information, and send a signal to power the visual indicator in response to the position of the implement arm assembly being outside the boundary of operational position.

Other aspects will become apparent by consideration of the detailed description and accompanying drawings.

### BRIEF DESCRIPTION OF THE DRAWINGS

FIG. 1 is a user's perspective view from an operator control station of a work vehicle according to one embodiment.

FIG. 2 is a perspective view of the work vehicle of FIG. 1 with a first section of electroluminescent coating being illuminated.

FIG. 3 is a perspective view of the work vehicle of FIG. 1 with a second section of electroluminescent coating being illuminated.

FIG. 4 is a schematic representation of a control system for a work vehicle such as the work vehicles shown in FIGS. 1, 5, and 7.

FIG. 5 is a user's perspective view from an operator control station of a work vehicle according to another embodiment.

FIG. 6 is a perspective view of the work vehicle of FIG. 5 with a first section of electroluminescent coating being illuminated.

FIG. 7 is a user's perspective view from an operator control station of a work vehicle according to yet another embodiment.

FIG. 8 is a perspective view of the work vehicle of FIG. 7 with a first section of electroluminescent coating being illuminated.

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Terms of degree, such as “substantially,” “about,” “approximately,” etc. are understood by those of ordinary skill to refer to reasonable ranges outside of the given value, for example, general tolerances associated with manufacturing, assembly, and use of the described embodiments.

In addition, it should be noted that a plurality of hardware and software based devices, as well as a plurality of different structural components may be utilized to implement embodiments described herein. In addition, it should be understood that embodiments described herein may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of embodiments described herein may be implemented in software (for example, stored on non-transitory computer-readable medium) executable by one or more processors. As such, it should be noted that a plurality of hardware and software based devices, as well as a plurality of different structural components may be utilized to implement the described embodiments. For example, “controller” and “control unit” described in the specification may include one or more electronic processors, one or more memory modules including non-transitory computer-readable medium, one or more input/output interfaces, and various connections (for example, a system bus) connecting the components.

### DETAILED DESCRIPTION

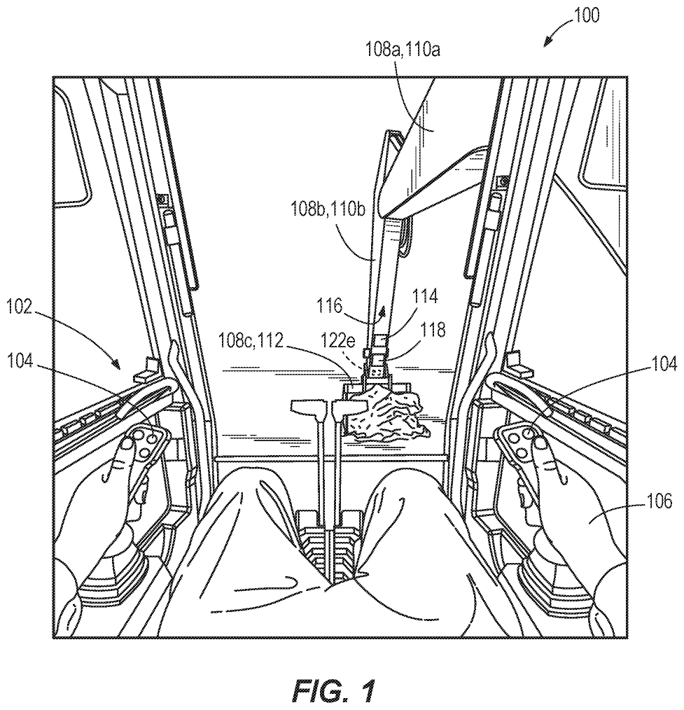

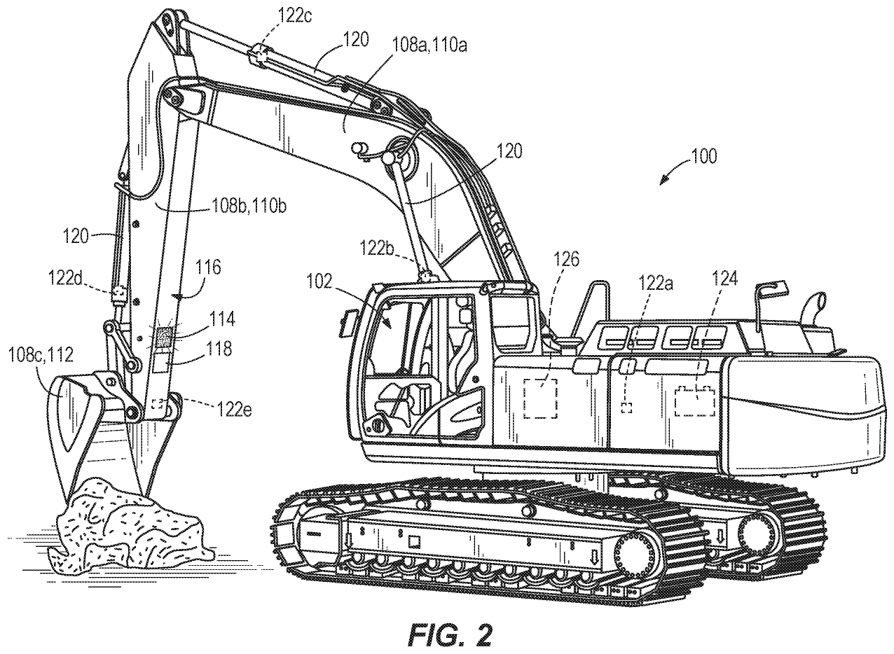

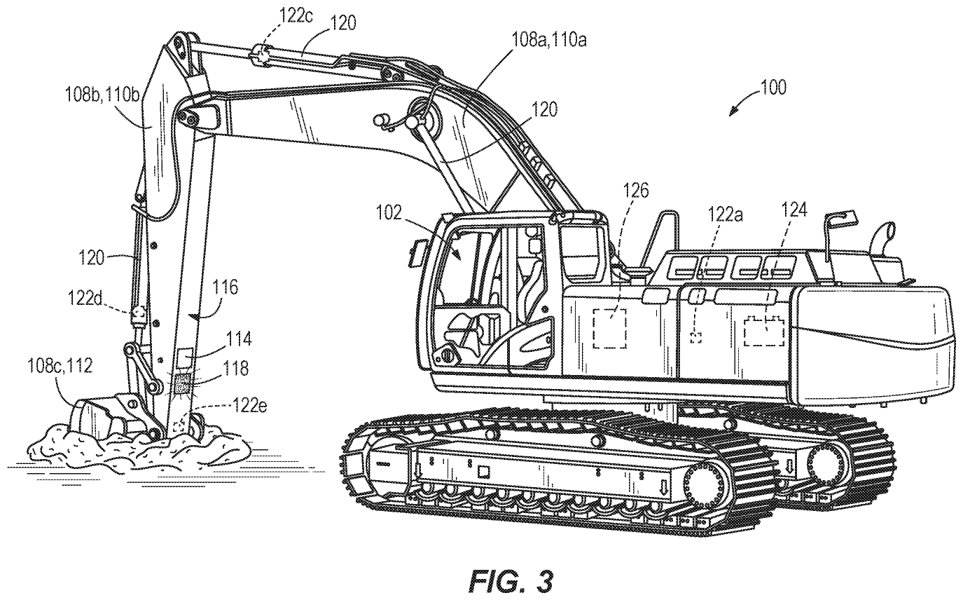

FIGS. 1-3 illustrate a first embodiment of a work vehicle 100. The work vehicle 100 may be, for instance, an excavator, such as a tracked excavator shown in FIGS. 2 and 3. The excavator 100 may instead be a wheeled excavator.

With reference to FIGS. 2 and 3, the work vehicle 100 includes an operator control station 102. The operator control station 102 may include, for instance, an operator cab that is partially or completely enclosed. Other embodiments may include an open operator control station 102 or a remote operator control station. As shown in FIG. 1, the operator control station 102 includes one or more operator controls 104 actuatable by a user 106. The operator controls 104 allow the user to move the work vehicle 100 along the ground.

The operator controls 104 further allow the user to control an implement arm assembly including at least one member 108 (such as at least one of members 108a, 108b, and 108c) of the work vehicle 100. In the illustrated embodiment, the member 108 is a linkage 110 (such as one of linkages 110a and 110b) connected to a work implement 112. The work implement 112 may include an excavation blade, shown in FIGS. 1-3 as an excavator bucket. In some embodiments, the work implement 112 may itself be considered another member 108c of the implement arm assembly of the work vehicle 100. The member 108 is movable relative to the operator control station 102 to, for instance, engage the ground.

The work vehicle 100 further includes at least a first visual indicator 114 positioned on and/or covering at least a portion of an exterior surface 116 of the member 108 outside the operator control station 102. The first visual indicator 114 may be on an exterior surface 116 of the member 108 that also faces the operator control station 102. This positioning is advantageous over indictors located inside the operator control station 102 because the visual feedback provided by the first visual indicator 114 may not require the user to lose visual contact with the member 108 or the surroundings being acted upon by movement of the member.

The first visual indicator 114 may include one or more light emitting diodes, incandescent bulbs, a section of electroluminescent coating, some combination thereof, and the like. Embodiments including the electroluminescent coating may be advantageous because such coatings may need little to no protection from objects impacting the member 108 during operation of the work vehicle 100. In some embodiments, the first visual indicator 114 is in the shape of a rectangle, but other shapes are contemplated herein including, for instance, one or more arrows, circles, ovals, triangles, indicia such as letters and/or numbers, and the like. The first visual indicator 114 may cover a small portion of the exterior surface 116 of a particular member 108, half of the exterior surface, a majority of the exterior surface, a plurality of discrete or connected exterior surfaces, and the like.

The work vehicle 100 illustrated in FIGS. 1-3 also includes a second visual indicator 118 positioned on and/or covering at least a portion of the exterior surface 116 of the member 108 facing the operator control station 102. The second visual indicator 118 may similarly include one or more light emitting diodes, incandescent bulbs, a section of electroluminescent coating, some combination thereof, and the like. In some embodiments, the second visual indicator 118 is on the same exterior surface 116 as the first visual indicator 114, but other embodiments may instead include the second visual indicator on a different exterior surface of the member 108 or on an exterior surface of a different member 108. The second visual indicator 118 is shown in FIGS. 1-3 as being the same general shape and same general size as the first visual indicator 114. In other embodiments, however, the second visual indicator 118 is, compared to the first visual indicator 114, of a different shape, a different size, a different color when illuminating, indicia having a different message, some combination thereof, and the like. Stated another way, the first and second visual indicators 114, 118 may be similar in appearance to each other, the same in appearance as each other, or different in appearance from each other.

Although the first and second visual indicators 114, 118 are shown as discrete sections on the same exterior surface 116, the present disclosure also contemplates intermingled or overlapping visual indicators. For instance, the first visual indicator 114 may include first section of electroluminescent coating applied directly to the exterior surface 116 of the member 108, and the second visual indicator 118 may include a second section of electroluminescent coating applied directly over the first section of electroluminescent coating. The second section of electroluminescent coating of the second visual indicator 118 may be applied thinly enough such that the light emitted from the first section of electroluminescent coating of the first visual indicator 114 can shine through the second section of electroluminescent coating. Other embodiments may include each visual indicator 114, 118 including a plurality of discrete “pixels” with the pixels of both visual indicators intermingled on the same exterior surface, much like how RGB pixels are arranged on a television or computer screen.

The work vehicle 100 illustrated in FIGS. 1-3 also includes a plurality of cylinder assemblies 120. Each cylinder assembly 120 includes one or more hydraulic actuators capable of pushing and/or pulling a corresponding member 108 of the work vehicle 100. For example, one cylinder assembly 120 pivots the work implement 112 relative to the linkage 110, another cylinder assembly pivots one linkage relative to another linkage, and still another cylinder assembly pivots the linkages and work implement relative to the operator control station 102.

As shown in FIGS. 2 and 3, the work vehicle 100 further includes one or more sensors 122 (such as one or more of sensors 122a, 122b, 122c, 122d, and 122e). Each of the sensors 122 may be configured to detect one or more conditions. In some embodiments, at least one sensor 122 of the work vehicle 100 includes a location-type sensor. One or more of the sensors 122 may additionally or alternatively include a global positioning system sensor, a temperature sensor, a flow rate sensor or flow meter, a pressure sensor, a proximity sensor, a motion sensor, and the like. The sensors 122 may be configured to detect one or more parameters including, but not limited to, a position of a member 108 (such as the work implements 112) relative to the operator control station 102, an absolute location based on a satellite uplink interface, a position of the work vehicle 100 relative to a designated reference point, a weight of a load carried by the member and/or the work vehicle generally, whether a worker is within a threshold radius of the work vehicle, a pressure of the hydraulic fluid in the hydraulic system of the work vehicle, a temperature of the engine of the work vehicle, and the like.

An example of one or more sensors 122 able to determine the relative position of the work implement 112 relative to the operator control station 102 includes sensors monitoring the amount of (or pressure of) hydraulic fluid provided to (or removed from) each cylinder assembly 120. Additionally or alternatively, the sensors 122 may include one or more proximity sensors with a tag detector placed on the outer cylinder of each cylinder assembly 120 and one or more detectable tags on the inner cylinder of each respective cylinder assembly. With the sensed information from the sensors 122, a calculation may be made that takes into account the operational parameters of each cylinder assembly 120, such as the operational length of the cylinder assembly. An example embodiment of determining the position of a work implement can be found in co-pending U.S. patent application Ser. No. 16/122,274, filed Sep. 5, 2018, the contents of which are incorporated by reference herein.

As will be understood by a person of ordinary skill in the art, the aforementioned sensors 122 may be a variety of different sensors capable of performing the function described herein. Additionally, it should be understood that the work vehicle 100 may include a greater or fewer number of sensors 122, or a different combination of sensors than those discussed above. For example, in some embodiments, the work vehicle 100 may include more than one sensor or more than one type of sensor in place of one of the sensors 122 discussed herein. In other embodiments, one or more of the sensors 122 may be excluded from the work vehicle 100. In some embodiments, one or more sensors 122 may be replaced by a user input that can be manually input by an operator of the work vehicle 100 via a user interface. Alternatively, one or more sensors may be replaced by machine logic or other control systems to identify a parameter that would otherwise be measured by a sensor 122 described herein. Further, although many of the sensors 122 are shown and described with regard to the cylinder assemblies 120 discussed above, some embodiments may include no sensors coupled to or located within respective cylinder assemblies. Some embodiments may include a single GPS sensor 122 located in the position of, for instance, the fifth sensor 122e in FIGS. 1-3. In other embodiments, the single sensor 122 may include a proximity sensor designed to recognize whether it is within a geofence or not.

As shown schematically in FIG. 2, the work vehicle 100 further includes at least one electricity source 124, such as a battery. The electricity source 124 may be coupled to the one or more sensors 122 to power the sensors. Further, the electricity source 124 may be selectively couplable to the first and second visual indicators 114, 118. In the illustrated embodiment, the sensors 122 and the visual indicators 114, 118 are all powered by the same electricity source 124, which is the battery of the work vehicle 100. It is contemplated herein, however, that the work vehicle 100 may have more than one electricity source 124. For instance, some or all of the sensors 122 may be connected to respective batteries. Additionally or alternatively, one or both of the visual indicators 114, 118 may be selectively couplable to respective batteries.

With continued reference to FIG. 2, the work vehicle 100 further includes one or more controllers 126. The one or more controllers 126 are configured to control the components of the work vehicle 100.

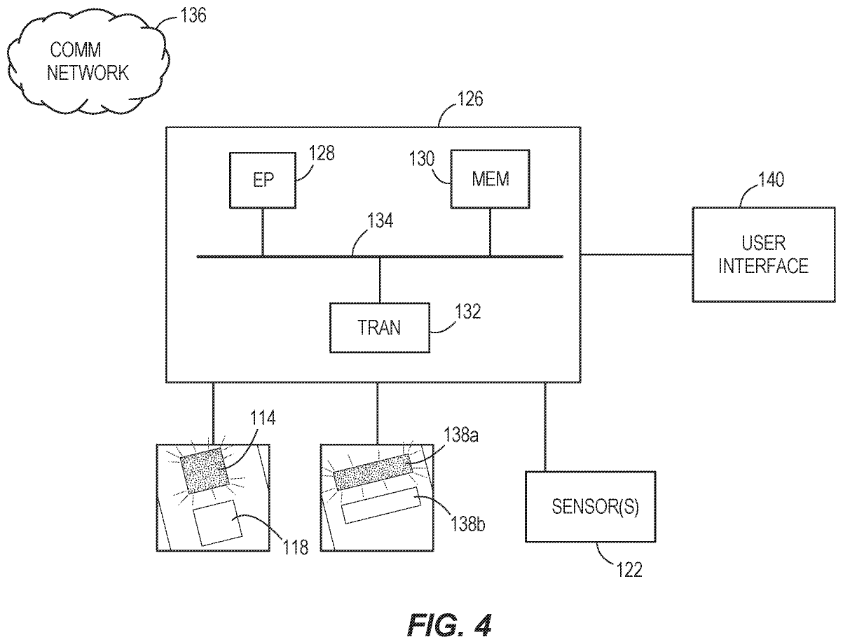

FIG. 4, for example, schematically illustrates a controller 126 included in the work vehicle 100 according to one embodiment. As illustrated in FIG. 4, the controller 126 includes an electronic processor 128 (for example, a microprocessor, application specific integrated circuit (ASIC), or other electronic device), a computer-readable medium 130, and a transceiver 132. The electronic processor 128, the computer-readable medium 130, and the transceiver 132 are connected by and communicate through one or more communication lines or buses 134.

It should be understood that the controller 126 may include fewer or additional components than those illustrated in FIG. 4 and may include components in configurations other than the configuration illustrated in FIG. 4. Also, the controller 126 may be configured to perform functionality additional to the functionality described herein. Further, the functionality of the controller 126 may be distributed among more than one controller. For example, the controller 126 may communicate with one or more additional controllers. The additional controllers may be internal or external to the controller 126. Likewise, the functionality described herein as being performed by the electronic processor 128 may be performed by a plurality of electronic processors included in the controller 126, a separate device, or a combination thereof. Furthermore, in some embodiments, the controller 126 may be located remote from the work vehicle 100.

The computer-readable medium 130 includes non-transitory memory (for example, read-only memory, random-access memory, or combinations thereof) storing program instructions (software) and data. The electronic processor 128 is configured to retrieve instructions and data from the computer-readable medium 130 and execute, among other things, the instructions to perform the methods described herein. In some embodiments, as illustrated in FIG. 4, the controller 126 communicates wirelessly with a communication network 136 via the transceiver 132. The transceiver 132 transmits data from the controller 126 to external systems, networks, devices, or a combination thereof and receives data from external systems, networks, devices, or a combination thereof. The transceiver 132 may also store data received from external sources to the computer-readable medium 130, provide received data to the electronic processor 128, or both.

The one or more sensors 122 described above transmit data to the controller 126 either by one or more wires or wirelessly via the communications network 136. Stated another way, the controller 126 is configured to receive input from the at least one sensor 122. An example of the program instructions stored on the computer-readable medium 130 includes a grade indication system program. For a grade indication system program, the input received from the sensors 122 to the controller 126 can correspond to at least one of the work implement 112 being on-grade, the work implement 112 being above grade, and the work implement 112 being below grade. This grade status data can correspond to one or more GPS sensors, proximity sensors, inertial measurement units, and the like. The controller 126, through this grade indication system program, processes the input from the sensors 122 in the electronic processor 128 and sends control commands to the visual indicators 114, 118. More specifically, the controller 126 sends commands (for instance, to one or more switches) to electrically couple the electricity source 124 to a given visual indicator 114, 118 based on the conditions sensed by the one or more sensors 122. In the example embodiment shown in FIGS. 1-3, the controller 126 is configured to electrically couple the first visual indicator 114 to the electricity source 124 when the controller receives input from the sensors 122 corresponding to the work implement 112 being above grade (FIG. 2). The controller 126 is also configured to electrically couple the visual indicator 118 to the electricity source 124 when the controller receives input from the sensors 122 corresponding to the work implement 112 being below grade (FIG. 3).

In an example of the operation of the embodiment discussed above, a user may operate the work vehicle 100 to excavate or otherwise work on a jobsite. From the operator control station 102, the user may view the work implement 112 as it interacts with the surroundings. The user (or another) may input desired parameters for the appropriate grade of the jobsite or a geofence for the jobsite via a user interface 140 that may be either in the operator control station 102 or remote therefrom. These parameters define an appropriate zone of operation for the work implement 112 including, for instance, the acceptable depth threshold for digging and the boundaries of the area of the jobsite. While the work implement 112 is within the zone of operation, as shown in FIG. 2, the user can see the first visual indicator 114 is illuminated. This feedback is already in or around the user's line of sight as he operates the work vehicle 100, providing a heads-up display type of indication that does not require a specialized headset or screen. Seeing the first visual indicator 114 is illuminated, the user can confidently proceed to dig deeper or to move the work vehicle 100 forward along the ground. Once the work implement 112 has passed beyond the bounds of the zone of operation, the first visual indicator 114 is no longer illuminated and instead the second visual indicator 118 is illuminated as shown in FIG. 3. Seeing the second visual indicator 118 is illuminated, the user can quickly and easily recognize he is currently digging too deeply or has moved the work implement 112 horizontally out of the geofence for the jobsite. This feedback can prompt the user to cease his current operation of the work vehicle 100 and move the work implement 112 in a different direction. Once the work implement 112 has moved back into the zone of operation, the second visual indicator 118 is no longer illuminated and the first visual indicator 114 is illuminated once more. The user can use this real-time or nearly real-time feedback to discover and work along the boundaries of the zone of operation. This visual feedback may be unobtrusive but easily recognizable. Further, this feedback is not dependent on sound conditions. As such, noisy conditions or the user wearing hearing personal protection equipment does not prevent the user from receiving the feedback from the indicators 114, 118.

In some alternative embodiments, the controller 126 may be configured to electrically couple the electricity source 124 to the first visual indicator 114 when the controller receives input from the sensors 122 and to electrically couple the electricity source to the second visual indicator 118 when the controller does not receive input from the sensors. In such embodiments, the sensors 122 may be configured to send input to the controller 126 only when a threshold condition has been exceeded.

In embodiments including only the first visual indicator 114, the controller 126 may be configured to electrically couple the first visual indicator with the electricity source 124 when the controller receives input from the at least one sensor 122. Alternatively, the controller 126 may do so when the controller receives no input from the at least one sensor 122.

Some embodiments of the work vehicle 100 include additional visual indicators 138a, 138b, and so on (shown schematically in dashed lines as optional in FIG. 4). In the example embodiment having a grade indication system program, the three or more visual indicators 114, 118, 138a may show a user how close to being on-grade the work implement 112 is at a given position. A center section of electroluminescent coating in a vertical series of sections could represent the on-grade target, and a section illuminated below the center section could show below grade while a section illuminated above the center section could show above grade. With more sections available in the system, more granularity for the position of the work implement 112 relative to an on-grade location is available.

Also shown schematically in FIG. 4, a user interface 140 is connected to the controller 126 to input and/or output information. The illustrated example in FIG. 4 shows the user interface 140 electrically coupled to the controller 126 by wire, but other embodiments include the user interface wirelessly coupled to the controller via the communications network 136. The user interface 140 may be on-board controls in the operator control station 102, a mobile computing device, a remote computer station, and the like. In any case, the controller 126 is configured to receive input regarding the control parameters based on input (or lack thereof) received from the one or more sensors 122. For the grade indication system program embodiment, the user interface 140 is used to designate the desired grade characteristics, such as depth and slope. Other user inputs, such as a geofence, weight limit warning value, engine temperature warning value, hydraulic system fluid pressure warning value, and the like may be input via the user interface 140. This user interface 140 can include the operator controls 104 and function as a general vehicle operational interface, or the user interface 140 may be a specialized component separate from the operator controls.

The user interface 140 may include a computer screen, a touch screen, a mobile device screen, one or more switches, one or more lights, and the like. The user may select the desired parameters via the user interface 140, and the user interface may also optionally display feedback including, for instance, the user's selection.

The controller 126 may additionally be configured to operate components of the work vehicle 100. For example, the controller 126 may be configured to operate the cylinder assemblies 120 to actuate the members 108 including the linkage 110 and the work implement 112. In the example of FIGS. 1-3, in addition to indicating the below grade condition with the second section of electroluminescent coating 118, the controller may be further configured to interrupt or ignore the control signals received from the operator controls 104 if the control signals command, for instance, to proceed farther below grade.

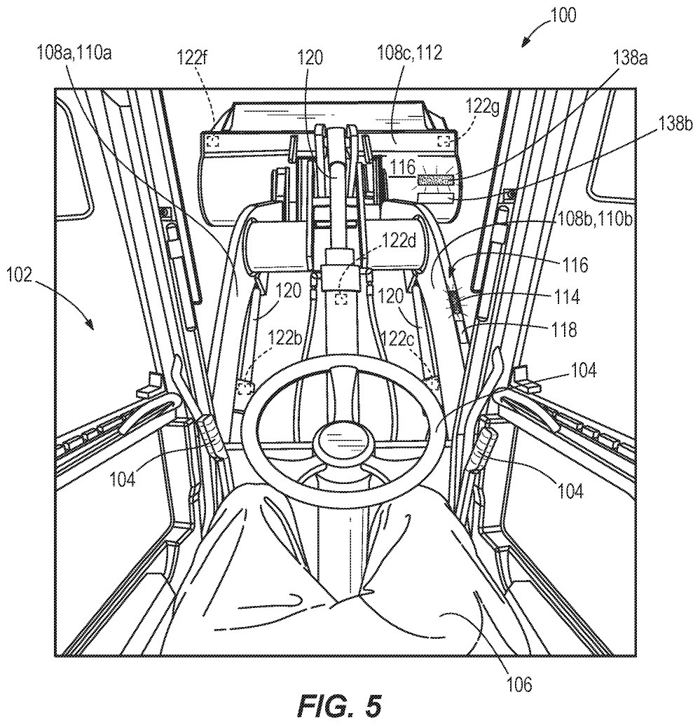

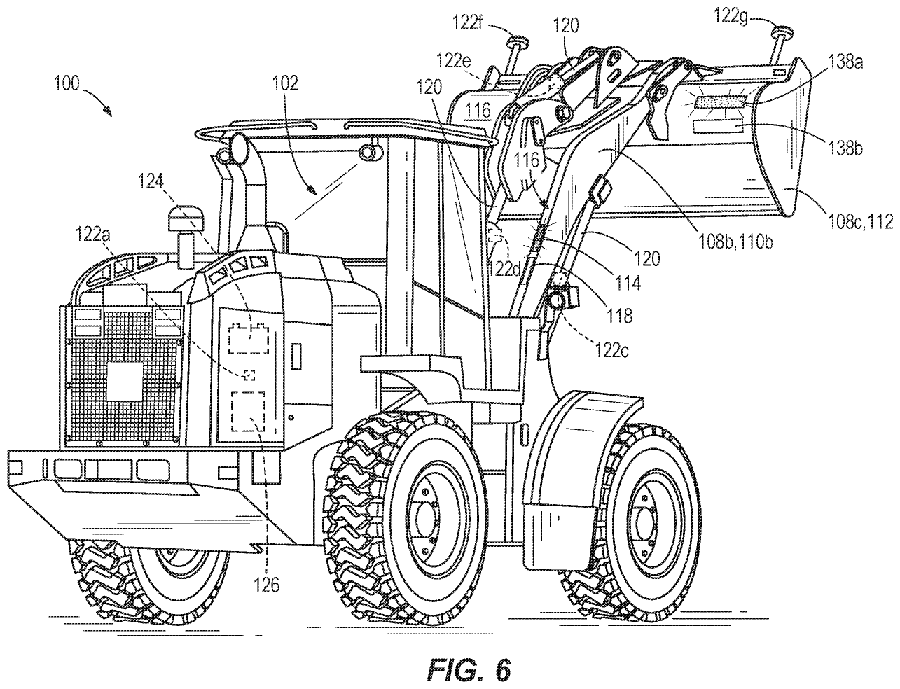

With reference to FIGS. 5 and 6, the work vehicle 100 may be, for instance, a loader. The loader 100 may be a wheeled loader or a track loader. The loader 100 is shown having the first and second visual indicators 114, 118 on the linkage 110 and also having third and fourth visual indicators 138a, 138b on the work implement 112, which is illustrated as a bucket. In some embodiments, the first and third visual indicators 114, 138a may both simultaneously indicate a first condition, and the second and fourth visual indicators 118, 138b may both simultaneously indicate a second condition. In this embodiment, the user may easily view the indications regardless of the orientation of the one or more members 108. Other embodiments may include the first and second visual indicators 114, 118 on the linkage 110 indicating the grade status as described above while the third and fourth visual indicators 138a, 138b indicate a different status, such as a good/bad indication regarding the threshold load weight carried by the work implement 112 and/or the linkages 110.

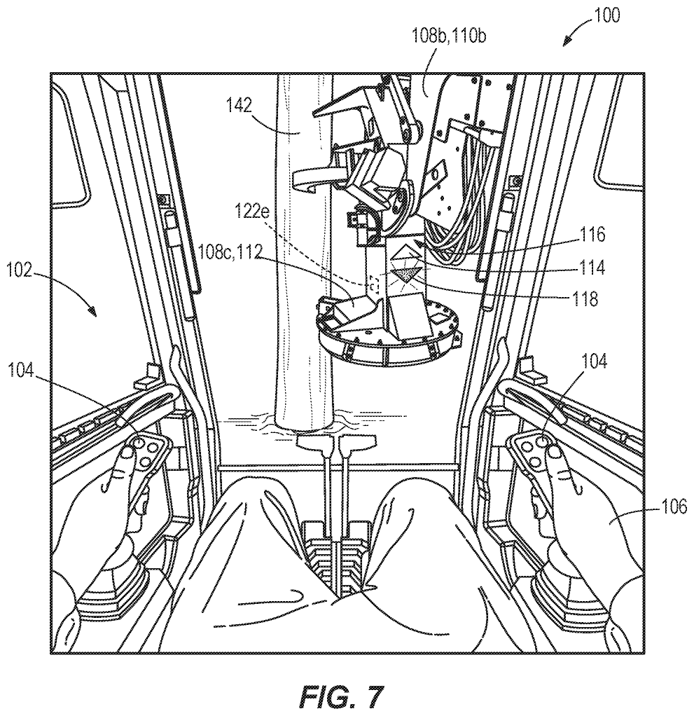

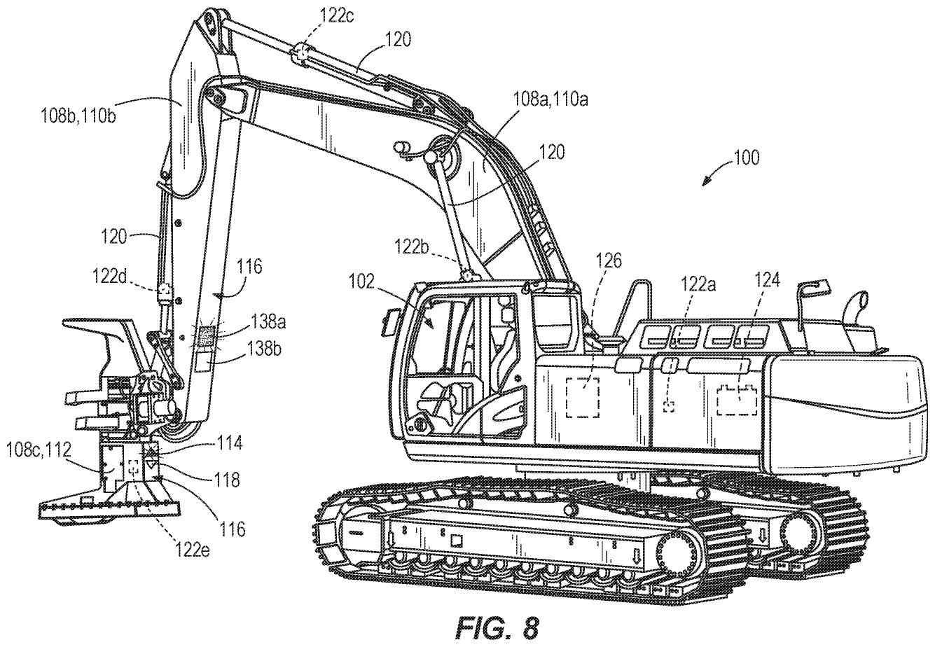

With reference to FIGS. 7 and 8, the work vehicle 100 may be, for instance, a feller buncher. The feller buncher 100 may include wheels or tracks as discussed above with regard to the excavator. The feller buncher 100 is shown having the first and second visual indicators 114, 118 on the work implement 112, which is illustrated as a forestry jib. In some embodiments, the visual indicators 114, 118 may indicate to a user whether a particular tree 142 the user approaches with the work implement 112 is within the geofence designated previously via the user interface 140. If the tree 142 is within the geofence, the first visual indicator 114 illuminates (with the color green for “go”, for instance). If the tree 142 is outside of the geofence, the second visual indicator 118 illuminates (with the color red for “stop”, for instance). Additionally or alternatively, the visual indicators 114, 118 (along with other potentially additional sections) may indicate to the user whether the work implement 112 (the forestry jib) is low enough to the ground to properly cut the tree 142 to leave a stump that is below an acceptable height threshold. If the work implement 112 is at the appropriate height, the first visual indicator 114 may illuminate. If the work implement 112 is too high, the visual indicator 118 may illuminate.

Although the disclosure has been described in detail with reference to certain—preferred embodiments, variations and modifications exist within the scope and spirit of one or more independent aspects of the disclosure as described. Various features and advantages of the disclosure are set forth in the following claims.

What is claimed is:

1. A work vehicle comprising:
a vehicle frame;
an operator control station coupled to the vehicle frame;
an implement arm assembly affixed to the vehicle frame outside the operator control station, the implement arm assembly movable relative to the vehicle frame and the operator control station and having an exterior surface;
at least one sensor configured to detect positional information of the implement arm assembly;
a visual indicator positioned on the exterior surface of the implement arm assembly;
a power source in selective communication with the visual indictor to power the visual indicator; and
a controller configured to
receive a signal from the at least one sensor indicative of the positional information, and
electrically couple the power source to the visual indicator in response to a portion of the implement arm assembly reaching a threshold position.

2. The work vehicle of claim 1, wherein the visual indicator includes a section of electroluminescent coating.

3. The work vehicle of claim 1, wherein the at least one sensor is configured to detect a position of the implement arm assembly relative to a position of another portion of the work vehicle.

4. The work vehicle of claim 1, wherein the at least one sensor includes a global positioning system sensor.

5. The work vehicle of claim 1, further comprising
an excavation blade connected to the implement arm assembly; and
wherein the threshold position of the implement arm assembly corresponds to at least one of a depth threshold and a slope threshold for the excavation blade.

6. The work vehicle of claim 1, wherein the visual indicator is a first visual indicator and further comprising
a second visual indicator positioned on the exterior surface of the implement arm assembly; and
wherein the controller is further configured to electrically couple the power source to only one of the first visual indicator and the second visual indicator at a time.

7. The work vehicle of claim 6, wherein
the first visual indicator includes a first section of electroluminescent coating; and
the second visual indicator includes a second section of electroluminescent coating.

8. The work vehicle of claim 7, wherein the first section of electroluminescent coating and the second section of electroluminescent coating are configured to illuminate as different colors.

9. The work vehicle of claim 7, wherein the first section of electroluminescent coating and the second section of electroluminescent coating are differently shaped sections.

10. The work vehicle of claim 9, wherein each of the first section of electroluminescent coating and the second section of electroluminescent coating is in the form of indicia including at least one of a letter and a number.

11. The work vehicle of claim 6, further comprising
a work implement connected to the implement arm assembly, the work implement including an exterior surface;
a third visual indicator positioned on the exterior surface of the work implement; and
a fourth visual indicator positioned on the exterior surface of the work implement.

12. The work vehicle of claim 11, wherein the controller is further configured to
illuminate the first visual indicator and the third visual indicator simultaneously; and
illuminate the second visual indicator and the fourth visual indicator simultaneously.

13. A work vehicle comprising:
a vehicle frame;
an operator control station coupled to the vehicle frame;
an implement arm assembly affixed to the vehicle frame outside the operator control station, the implement arm assembly movable relative to the vehicle frame and the operator control station and having an exterior surface;
at least one sensor configured to detect weight information of a load carried by the implement arm assembly;
a visual indicator positioned on the exterior surface of the implement arm assembly;
a power source in selective communication with the visual indictor to power the visual indicator; and
a controller configured to
receive a signal from the at least one sensor indicative of the weight information, and
electrically couple the power source to the visual indicator in response to the weight of the load carried by the implement arm assembly exceeding a threshold weight.

14. The work vehicle of claim 13, wherein the visual indicator is a first visual indicator and further comprising
a second visual indicator positioned on the exterior surface of the implement arm assembly; and
wherein the controller is further configured to electrically couple the power source to the second visual indicator in response to the weight of the load carried by the implement arm assembly being below the threshold weight.

15. The work vehicle of claim 14, further comprising
a bucket connected to the implement arm assembly, the bucket including an exterior surface;
a third visual indicator positioned on the exterior surface of the bucket; and
a fourth visual indicator positioned on the exterior surface of the bucket.

16. The work vehicle of claim 15, wherein the controller is further configured to
electrically couple the power source to the first visual indicator and the third visual indicator simultaneously, and
electrically couple the power source to the second visual indicator and the fourth visual indicator simultaneously.

17. The work vehicle of claim 15, wherein each of the visual indicators includes a respective section of electroluminescent coating.

18. A visual indication system comprising:
at least one sensor configured to detect positional information of a portion of an implement arm assembly of a work vehicle;
a visual indicator configured to be affixed to the implement arm assembly to illuminate an exterior surface thereof outside of an operator control station of the work vehicle; and
a controller configured to
receive an input signal regarding a boundary of operational position of the portion of the implement arm assembly,
receive a signal from the at least one sensor indicative of the positional information, and
send a signal to power the visual indicator in response to the position of the portion of the implement arm assembly being outside the boundary of operational position.

19. The visual indication system of claim 18, wherein the visual indicator is a first visual indicator and further comprising:
at least a second visual indicator configured to be affixed to the implement arm assembly to illuminate an exterior surface thereof outside of the operator control station of the work vehicle; and
wherein the controller is further configured to send a signal to power the second visual indicator in response to the position of the portion of the implement arm assembly being within the boundary of operational position.

20. The visual indication system of claim 19, wherein each of the first visual indicator and the second visual indicator includes a respective section of electroluminescent coating.
